(19) United States
(12) Patent Application Publication
(10) Pub. No.: US 2015/0329709 A1
(43) Pub. Date: Nov. 19, 2015

(54) RUBBER COMPOUND COMPRISING POLYBUTADIENE IN THE POLYMER BASE

(71) Applicant: BRIDGESTONE CORPORATION, Tokyo (JP)

(72) Inventor: Francesco BOTTI, Roma (IT)

(73) Assignee: BRIDGESTONE CORPORATION, Tokyo (JP)

(21) Appl. No.: 14/652,147

(22) PCT Filed: Dec. 18, 2013
(86) PCT No.: PCT/IB2013/061114

§ 371 Date: Jun. 15, 2015

(30) Foreign Application Priority Data
Dec. 18, 2012 (IT) RM2012A000645

(51) Int. Cl. C08L 9/06

(52) U.S. Cl. CPC C08L 9/06; C08L 2205/025

(57) ABSTRACT

A method of producing rubber compounds having a cross-linkable polymer base at least partly composed of polybutadiene. The method includes a first mixing step in which the cross-linkable polymer base is mixed with at least one reinforcing filler; and at least a second mixing step in which the mix from the first mixing step is mixed with a curing system. The method also includes a preliminary mixing step prior to the first mixing step, and in which only the polybutadiene of the polymer base is mixed with a reinforcing resin, with no reinforcing filler.

### TECHNICAL FIELD

The present invention relates to a rubber compound comprising polybutadiene in the polymer base.

More specifically, the present invention relates to a tyre compound, and more specifically to a tread compound, to which the following description refers purely by way of example.

### BACKGROUND ART

The term ‘cross-linkable, unsaturated-chain polymer base’ is intended to mean any natural or synthetic, non-cross-linked polymer capable of assuming all the chemical, physical and mechanical characteristics typical of elastomers cross-linked (cured) with sulphur-based systems.

The term ‘curing system’ is intended to mean compounds, such as sulphur and accelerants, by which to cross-link the polymer base.

The term ‘methylene donor compound’ is intended to mean a compound capable of acting as a cross-linking agent by means of methylene bridges in the presence of a ‘methylene acceptor compound’.

Polybutadiene rubber is normally mixed with other types of rubber to produce various tyre portions, because of the advantages it affords in terms of wear, abrasion and shear resistance.

However, compounds with a polymer base composed of a mixture of rubbers comprising polybutadiene pose the problem of dispersing the reinforcing filler, such as carbon black or silica; in the polymer base. In fact, the reinforcing filler disperses less in polybutadiene rubber than in others, such as natural or styrene-butadiene rubber.

Uneven dispersion of the reinforcing filler invariably results in dissimilar technical characteristics of the compound, and hence in a tyre portion that is more easily subject to failure phenomena.

A common practice to solve this problem is to increase the reinforcing filler. But, though this provides for improvement in terms of abrasion resistance, it also reduces rolling resistance.

One possible solution to the problem is to functionalize the reinforcing filler to make it more similar to polybutadiene. Such a solution, however, is obviously complex and expensive, and therefore holds little interest industrially.

Another possible solution is to premix the polybutadiene rubber and the reinforcing filler separately. This has proved unsatisfactory, however, because of the poor affinity of polybutadiene rubber and the reinforcing filler, and the increase in hysteresis and therefore reduction in rolling resistance.

A method is therefore needed, which allows the use in compounds of polybutadiene rubber in a mixture of polymer bases, without producing any dissimilar technical characteristics of the compound or any reduction in rolling resistance.

The Applicant has surprisingly devised a method by which to solve the dissimilarity problem posed by the poor affinity of polybutadiene rubber and the reinforcing filler, while at the same time improving rolling resistance.

### DISCLOSURE OF INVENTION

One object of the present invention is a method of producing rubber compounds comprising a cross-linkable polymer base at least partly comprising polybutadiene; said method comprising a first mixing step in which the cross-linkable polymer base is mixed with at least one reinforcing filler; and said method being characterized by comprising a preliminary mixing step prior to said first mixing step, and in which only the polybutadiene of said polymer base is mixed with a reinforcing resin, with no reinforcing filler.

At said preliminary mixing step, the reinforcing resin preferably ranges from 1 to 70 parts, and even more preferably from 10 to 40 parts, per 100 parts of polybutadiene.

Preferably, said reinforcing filler comprises a methylene acceptor compound combined with a methylene donor compound.

Preferably, the methylene acceptor compound is a phenol formaldehyde resin.

Preferably, the methylene donor compound is hexamethoxymethyl melamine.

Preferably, the ratio in parts of the methylene acceptor compound to the methylene donor compound ranges from 2 to 10.

Preferably, the reinforcing filler comprises carbon black.

Preferably, in addition to polybutadiene, the cross-linkable polymer base also comprises natural rubber or styrene-butadiene rubber.

Another object of the present invention is a rubber compound produced using the method according to the present invention.

Another object of the present invention is a tyre portion made from a compound produced using the method according to the present invention; said portion preferably being the tread.

Another object of the present invention is a tyre comprising a portion made from a compound produced using the method according to the present invention.

### BEST MODE FOR CARRYING OUT THE INVENTION

The following are a number of non-limiting embodiments, purely by way of example, for a clearer understanding of the present invention.

### Examples

Four rubber compounds (A-D) were produced: compound A is a first control example representing a commonly used compound; compound B is a second control example containing a larger amount of reinforcing filler to improve abrasion resistance; compound C is a third control example, in which a reinforcing resin was added at the first mixing step; and compound D is an example of the invention, in which a preliminary mixing step is added to mix the polybutadiene with the reinforcing resin.

Compounds A-D were produced using the method described below:

### Compound Production

(Preliminary Mixing Step—Only for Compound D)

Prior to mixing, a 230-270-litre tangential-rotor mixer was loaded with the polybutadiene rubber, and the reinforcing resin composed of phenol formaldehyde resin combined with hexamethoxymethyl melamine.

The mixer was operated at a speed of 40-60 rpm, and the resulting mix was unloaded on reaching a temperature of 140-160° C.

### First Mixing Step

Prior to mixing, a 230-270-litre tangential-rotor mixer was loaded with the cross-linkable polymer base as a whole (including the polybutadiene from the preliminary mixing step for compound D), carbon black, silica, silane bonding agent, and, only for compound C, the reinforcing resin.

The mixer was operated at a speed of 40-60 rpm, and the resulting mix was unloaded on reaching a temperature of 140-160° C.

### Second Mixing Step

The curing system was added to the mix from the first mixing step; the mixer was operated at a speed of 20-40 rpm; and the resulting mix was unloaded on reaching a temperature of 100-110° C.

Table I shows the compositions in phr of the four compounds.

TABLE I

| | A | B | C | D |
|---|---|---|---|---|
| S-SBR | 80 | | | |
| BR | 20* | | | 20** |
| Carbon black | 7.5 | | | |
| Silica | 55 | 75 | 55 | 55 |
| Silane bonding agent | 5.5 | 7.5 | 5.5 | 5.5 |
| Methylene acceptor | — | — | 5.0* | 5.0** |
| compound | | | | |
| Methylene donor compound | — | — | 1.67* | 1.67** |

| | |
|---|---|
| Sulphur | 1.5 |
| Accelerant | 3.2 |

*added directly at the first mixing step.
**used at the preliminary mixing step.

In Table I:

S-SBR is a styrene-butadiene rubber solution with a mean molecular weight of 800-1500×10³ and 500-900×10³ respectively, and containing 10-45% styrene, 20-70% vinyl, and 0-30% oil.

BR is a polybutadiene rubber with a 1,4 cis content of at least 40%.

The silica used is marketed by EVONIK as VN3, and has a surface area of 170 m²/g.

The silane bonding agent used has the formula (CH₃CH₂O)₃Si (CH₂)₃SS (CH₂)₃Si(OCH₂CH₃)₃ and is marketed by EVAONIK as S175.

The methylene acceptor compound is phenol formaldehyde.

The methylene donor compound is hexamethoxymethyl melamine.

The accelerant is a mixture of TBBS, METS and DPG.

The compounds produced as described above were cured and tested for rolling and abrasion resistance.

The 60° C. tanδ values for assessing rolling resistance were measured as per ISO Standard 4664. As anyone skilled in the art knows, the 60° C. tanδ values are closely related to rolling resistance. More specifically, the lower the 60° C. tanδ value, the better the rolling resistance.

Abrasion resistance was tested as per DIN Standard 53 516.

Table II shows the test results indexed with respect to control compound A.

TABLE II

| | A | B | C | D |
|---|---|---|---|---|
| tanδ at 60° C. | 100 | 120 | 100 | 95 |
| Abrasion resistance | 100 | 107 | 100 | 111 |

As shown by the results in Table II, compound D produced using the method according to the present invention shows improved characteristics in terms of both rolling resistance (lower tanδ at 60° C. value) and, surprisingly, abrasion resistance.

Comparison with compound C shows that, to achieve the advantages sought, it is not enough to simply use the reinforcing resin in the compound, but it must be premixed separately with the polybutadiene rubber as per the essential characteristic of the present invention.

1. A method of producing rubber compounds comprising a cross-linkable polymer base at least partly comprising polybutadiene; said method comprising a first mixing step in which the cross-linkable polymer base is mixed with at least one reinforcing filler; and
said method being characterized by comprising a preliminary mixing step prior to said first mixing step, and in which only the polybutadiene of said polymer base is mixed with a reinforcing resin, with no reinforcing filler.

2. A method as claimed in claim 1, characterized in that, at said preliminary mixing step, the reinforcing resin ranges from 1 to 70 parts per 100 parts of polybutadiene.

3. A method as claimed in claim 2, characterized in that, at said preliminary mixing step, the reinforcing resin ranges from 10 to 40 parts.

4. A method as claimed in claim 1, characterized in that said reinforcing filler comprises a methylene acceptor compound combined with a methylene donor compound.

5. A method as claimed in claim 4, characterized in that the methylene acceptor compound is a phenol formaldehyde resin.

6. A method as claimed in claim 4, characterized in that the methylene donor compound is hexamethoxymethyl melamine.

7. A method as claimed in claim 4, characterized in that the ratio in parts of the methylene acceptor compound to the methylene donor compound ranges from 2 to 10.

8. A method as claimed in claim 1, characterized in that the reinforcing filler comprises carbon black.

9. A method as claimed in claim 1, characterized in that, in addition to polybutadiene, the cross-linkable polymer base also comprises natural rubber or styrene-butadiene rubber.

10. A rubber compound produced using the method according claim 1.

11. A tyre portion, characterized by being made from a compound as claimed in claim 10.

12. A tread, characterized by being made from a compound as claimed in claim 10.

13. A tyre comprising a portion as claimed in claim 11.
